(19) United States
(12) Patent Application Publication
(10) Pub. No.: US 2004/0159653 A1
(43) Pub. Date: Aug. 19, 2004

(54) Detachable temperature controller

(75) Inventor: Lugee Li, Dongguan City (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Dongguan Eande Electrical Products Co. Ltd., Dongguan City (CN)

(21) Appl. No.: 10/777,861

(22) Filed: Feb. 12, 2004

Related U.S. Application Data
(63) Continuation of application No. 09/923,699, filed on Aug. 7, 2001, now abandoned.

(30) Foreign Application Priority Data
Aug. 8, 2000 (CN) 00246957 .X

(51) Int. Cl. H05B 1/02

(52) U.S. Cl. 219/494; 219/490

(57) ABSTRACT

A detachable temperature sensor has two parts, a switch to control a temperature and a magnetic socket to connect the sensor to a power source. The switch has a plug to connect with an electrical appliance and electrical contacts and an iron sheet to connect with the magnetic socket. The magnetic socket has a housing and is connected to the power cord to a wall socket. The magnetic socket includes power inlet contact blades and a permanent magnetic iron sheet. When the switch and the socket are connected, a magnetic circle connects the permanent magnetic iron sheet with the iron sheet of the switch to connect the switch to the power. While in use, if the magnetic socket is pulled, the magnetic socket separates from the sensor switch, cutting power to the electrical appliance.

### BACKGROUND OF THE INVENTION

1. Field of the Invention

This invention relates to the detachable temperature controller.

Nowadays there are some disadvantage of the common electrical appliances in the marketing. If there is a force to draw it, the electrical appliance will be fallen down or inclined; the wire and the connecting parts with electrical appliances will be injured. Meanwhile something dangerous will take place, such as the electric shock and leakage. In order to avoid this phenomenon, we invent this kind of new detachable temperature controller.

2. Prior Art Statement

This is the new detachable temperature controller, which has a very important characteristic. If there is the force to draw it, the sensor switch can be separated from the magnetic socket to ensure it safe. And the force requirement: when you draw it horizontally, the force must be 2-5 kg because we have to ensure the switch and magnetic socket connected tightly and this force is proper to user; when you draw it at over 15 degree, the force will be under 0.8 kg to separate the sensor switch from magnetic socket easily.

### SUMMARY OF THE INVENTION

It is an object of this invention to provide a new, convenient, safe, ideal detachable temperature control that can overcome the lack of the prior known temperature regulating control units to comply with the common electrical appliances. This kind of connecting method can be generalized to ensure the electrical appliances safe, not only the switch to control the temperature and the magnetic socket, but also the switch to control the time or other kinds of switch and the magnetic socket.

This temperature controller is the improved products. It consists of two parts, one is the sensor switch to control the temperature, the other is the magnetic socket to connect the power. The described switch includes the temperature controller housing 4, the sensor switches 1 to control circuit and plug 3 to connect the electrical appliance ,a couple of power terminals 6 to conduct the magnetic socket power to the switch. The magnetic socket includes magnetic socket housing 16, two power inlet contact blade 8 and the permanent magnet 9 to input the magnetic socket housing 16, magnetic-iron sheet 7 to make the magnetic circuit back. There is the difference between the traditional temperature controller and the new temperature controller. The new temperature control part is separated from the power parts and they are connected by the magnet. If there is the force to draw it, the sensor switch can be separated from the magnetic socket in order to ensure it safe.

Please find the further information with reference to the following drawing:

### BRIEF DESCRIPTION OF THE DRAWING

FIG. 1 is a schematic entire view of the detachable temperature controller;

FIGS. 2(a), (b) is the fragmentary view of the temperature control unit and the magnetic socket parts;

FIGS. 3(a),(b) is the internal structure of FIG. 2;

FIG. 4 is the internal structure after two parts connection.

### DESCRIPTION OF THE PREFERRED EMBODIMENT

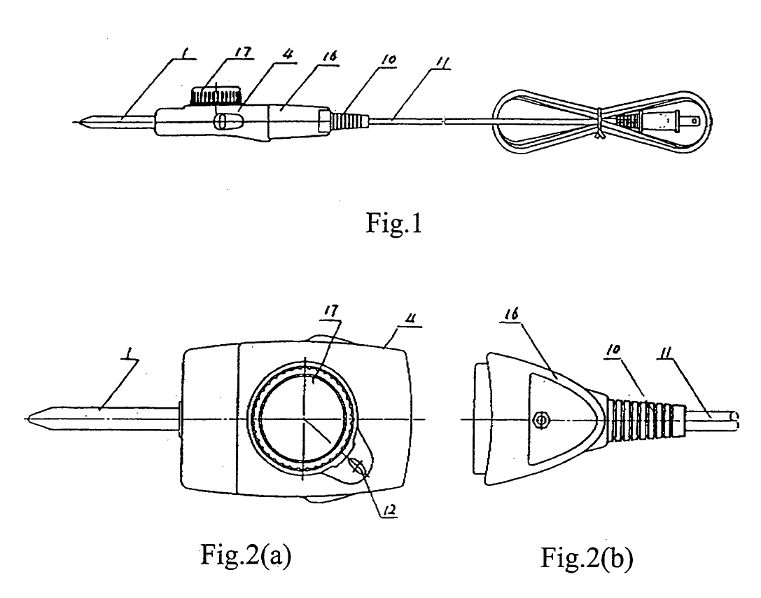

Refer to FIG. 1,FIGS. 2(a),(b),the new temperature controller includes the switch to control the temperature and the magnetic socket to control the power. There are the following parts in details: the sensor switch 1, the temperature controlling housing 4, the temperature adjustment controls 17 of sensor switch 1,indication lamp 12,magnetic socket housing 16,rubber bushing 10 and power cord 11 and so on.

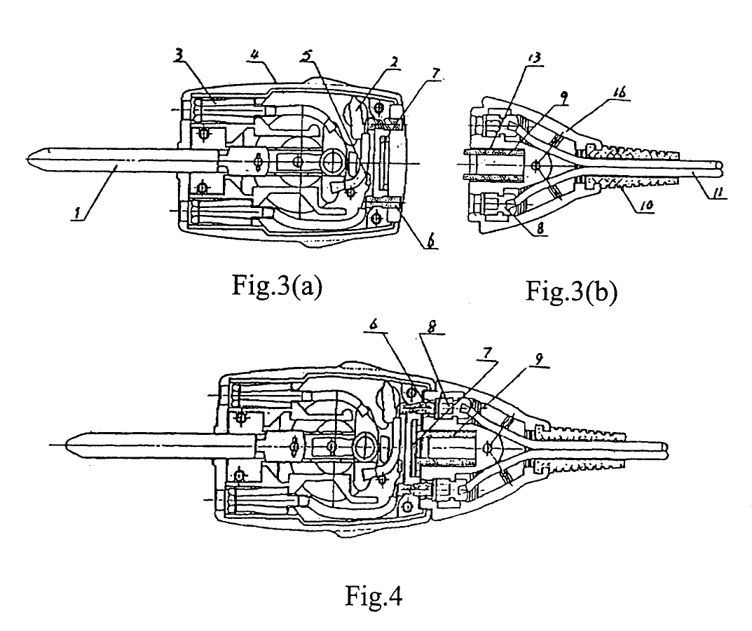

In the internal structure of FIGS. 3(a), (b), the sensor switch 1 input the middle of the temperature controlling housing 4; there is plug 3 in the sensor switch 1 to connect the electrical appliance. What's more, a couple of electrical contact 6 and iron sheet 7 input the terminal of temperature housing 4 to connect the magnetic socket. In the sensor switch there is a neon lamp 2 and resistor 5 to indicate the power on/off. The other magnetic socket parts includes: a couple of power inlet contact blade 8 and the permanent magnetic-iron 9 to input the magnetic socket housing 16.

FIG. 4 is the internal structure after the two parts connection. When two parts are connected, the permanent magnetic-iron 9 will connect the iron sheet 7 through the magnetic circle 13 so that a couple of electrical contact 6 will connect the power inlet contact blade 8. In this way, it makes the power back/open. The magnetic circle 13 is oxygenated iron sheet which conduct the magnetic produced by the permanent magnetic-iron

When using, we connect the temperature controller with the electrical appliance, then turn the temperature controller button to the desired temperature, then plug the power cord into the socket, then indication lamp will be on. When heating to the desired temperature, the terminal of sensor switch will cut the power. When the temperature is lower than the desired temperature, the contact point of sensor switch will be back automatically, the power will continue heating. In this way we can achieve the purpose of the temperature controller's circulation. If there is the force to draw it, its sensor switch will be separated from the magnetic socket to cut the power to ensure the electrical appliance safe. In this way, the power contact blade will be not nude so something dangerous won't take place, such as the electric shock, leakage incidents.

In this new invention there is the focus that the sensor switch to control the temperature connect the magnetic socket to control the power through the magnetic. If there is the force to draw it, the sensor switch can be separated from the magnetic socket in order to ensure the safety of the electrical appliance.

What is claimed is:

1. A detachable temperature controller comprising:
a temperature control unit comprising:
a housing having a tag end and a device end;
power outlet plugs disposed on the device end for transmitting electrical power to an electrical device;
power inlet contacts disposed on the tag end for receiving electrical power;
a sensor switch disposed at a middle position of the housing controlling electrical connection between the power inlet contacts and the power outlet plugs; and
an iron sheet disposed on the tag end of the temperature controlling housing; and
a magnetic socket part comprising:
a pair of power contact blades positioned to mate with the power inlet contacts on the temperature control unit; and
a permanent magnetic-iron positioned for interacting with the iron sheet of the temperature control unit;
wherein, when the power inlet contacts are electrically connected to the power contact blades, the permanent magnetic-iron attracts the iron sheet resulting in a magnetic coupling of the temperature control unit and the magnetic socket part.

2. The detachable temperature controller according to claim 1 further comprising:
a magnetic circle surrounding the permanent magnetic-iron for completing the magnetic coupling.

3. The detachable temperature controller according to claim 1 wherein the iron sheet is oxygenated iron.

4. The detachable temperature controller according to claim 1 wherein the temperature control unit is for controlling power to an electrical heating device, wherein the sensor switch passes power from the power inlet contact blades to the electrical heating device when sensed temperature is less than a desired temperature and wherein the sensor switch interrupts power from the power inlet contact blades to the electrical heating device when sensed temperature is at a desired temperature.

5. A detachable controller comprising:
a switching element within a first housing and adapted for electrical connection to an electrical device; and
a magnetic socket within a second housing, the magnetic socket being adapted for electrical connection to a power source and adapted for electrical and magnetic coupling to the switching element;
wherein overcoming the magnetic coupling to create physical separation of the magnetic socket from the switching element terminates power from the power source to the switching element.

6. The detachable controller of claim 5 wherein the electrical device is an electrical heating device, and wherein switching element comprises:
a sensor switch which passes power from the power source to the electrical heating device when sensed temperature is less than a desired temperature and which interrupts power from the power source to the electrical heating device when sensed temperature is at a desired temperature.

7. The detachable controller of claim 5 wherein the switching element comprises:
a magnetic iron sheet disposed within the first housing, the magnetic iron sheet being electrically isolated from the electrical circuit transmitting power to the electrical device.

8. The detachable controller of claim 7 wherein the magnetic socket comprises:
a permanent iron magnet within the second housing extending longitudinally toward the switching element; and
a magnetic circle within the second housing and wrapped around the permanent iron magnet for conducting a magnetic field produced by the permanent iron magnet.

9. A magnetically coupled controller comprising:
a sensing element comprising:
a first housing having a device end and an opposing coupling end;
two power outlet terminals on the device end of the first housing;
two power inlet terminals on the coupling end of the first housing and extending into the first housing; and
a sensor switch controlling completion of an electrical circuit from the two power inlet terminals to the two power outlet terminals; and
an iron sheet disposed on the coupling end of the first housing; and
a socket element for mating with the coupling end of the sensing element, the socket element comprising:
a plug for connection to a power source;
a second housing;
electrical contact blades within the second housing and positioned to mate with the two power inlet terminals of the sensing element;
an electrical power cord running from the plug to the electrical contact blades; and
a permanent magnet within the second housing and positioned to mate with the iron sheet of the sensing element;
wherein the socket element is magnetically coupled to the sensing element via magnetic attraction between the permanent magnet and the iron sheet.

10. The magnetically coupled controller of claim 9, further comprising a magnetic circle extending around the permanent magnet and overhanging an end of the permanent magnet, wherein the magnetic circle carries a magnetic field between the permanent magnet and the iron sheet.

11. The magnetically coupled controller of claim 9, further comprising a magnetic circle formed of oxygenated iron carrying a magnetic field between the permanent magnet and the iron sheet.

12. The magnetically coupled controller of claim 9 wherein the second housing shields the electrical contact blades of the socket element from direct contact when not in use.

13. The magnetically coupled controller of claim 9 wherein, if the magnetic coupling between the socket element and the sensing element is broken, power to the sensing element is terminated.

14. The magnetically coupled controller of claim 9, wherein the iron sheet is electrically isolated from the power terminals and extending such that a surface area of the iron sheet is maximized in a direction of the coupling end.
